(19) United States
(12) Patent Application Publication
(10) Pub. No.: US 2008/0076328 A1
(43) Pub. Date: Mar. 27, 2008

(54) Method for producing surface coatings on components

(75) Inventors: Guenter Zenzinger, Petershausen (DE); Herbert Zisik, Landshut (DE)

Correspondence Address: Davidson, Davidson & Kappel, LLC, 485 17th Avenue, 14th Floor, New York, NY, 10018, US

(73) Assignee: MTU Aero Engines GmbH, Muenchen (DE)

(21) Appl. No.: 11/821,751

(22) Filed: Jun. 25, 2007

(30) Foreign Application Priority Data
Sep. 27, 2006 (DE) DE102006045666.1

(51) Int. Cl. B24C 1/00; C23C 4/08; G01J 4/00

(52) U.S. Cl. 451/38; 356/369; 427/455

(57) ABSTRACT

A method for producing surface coatings on gas turbine components and/or for measuring abrasive material residues on gas turbine components, including: -abrasively blasting a surface of the component using an abrasive material, a portion of this abrasive material remaining on or in this surface of the component; -detecting abrasive material which has remained on or in the surface of the component; and -applying a coating to the surface of the component is disclosed.

This claims the benefit of German Patent Application No. DE 10 2006 045 666.7, filed on Sep. 27, 2006 and hereby incorporated by reference herein.

### BACKGROUND

The present invention relates to a method for producing surface coatings on components, in particular on gas turbine components, such as gas turbine components of aircraft engines, for example.

The components to be coated are typically abrasively blasted prior to the coating process in order to provide an adequate adhesion of thermally spray-applied coatings. Conditionally upon the particular process, abrasive material is worked into the component surface. However, the amount or proportion of the abrasive material that is worked in must not be too high, since, otherwise, the coating will exhibit inadequate adhesiveness.

In this context, related art methods provide for test specimens to be abrasively blasted along with the structural component and to be subsequently metallographically evaluated in a destructive process. Thus, it is not the component itself that is metallographically evaluated, but rather test specimens, which undergo an analogous process.

### SUMMARY OF THE INVENTION

Against this background, it is an object of the present invention to devise a method for measuring abrasive material residues on components that will entail relatively little outlay.

In accordance with one particular aspect, it would also be desirable to devise a method for producing surface coatings on components that will ensure a good adhesion of the surface coating while entailing little outlay.

In particular, a method is provided for producing surface coatings on components and, respectively, for measuring abrasive material residues on components. It is provided, in particular, that the method for producing surface coatings on components includes abrasively blasting these components with abrasive material prior to the coating process.

In this sense, the components may, in particular, be gas turbine components, such as gas turbine components of aircraft engines, for example.

It is provided for a surface of the component to first be abrasively blasted with an abrasive material, a portion of this abrasive material remaining on or in this surface of the component.

To the extent that the method is used to produce a surface coating, the surface in question may be the surface to be coated, and the corresponding component, the component to be coated.

Abrasive material, which has remained on or in the surface of the component, is subsequently detected; respectively, it is determined whether abrasive material has remained on or in the surface of the component. To the extent that the method is provided for producing surface coatings on components, once the abrasive material is detected, the coating is applied to the surface, respectively to the surface to be coated of the component, respectively to the component to be coated.

One advantageous embodiment provides for the abrasive material, which has remained on or in the surface of the component, to be detected in a contactless and/or nondestructive process.

In accordance with one especially preferred embodiment of the present invention, the abrasive material, on the one hand, and the material or base material of the component, on the other hand, are made of materials which differ from one another by their absorptivity, respectively, reflectivity to electromagnetic radiation.

Another especially advantageous refinement of the present invention provides for the abrasive material to absorb and, respectively, reflect electromagnetic radiation in defined spectral regions, differently from the (base) material (of the component), and for it to be uniquely detectable or detected by measuring this behavior. To this end or predominantly to this end, it may be provided to utilize the spectral regions of visible light and the infrared wavelength region, for example.

It may be provided for abrasive media particles to be individually detected at a geometrically high resolution and/or for the surface-area proportion to be determined. Another refinement provides for the integral change in the reflectivity and/or emissivity to be recorded.

In accordance with one advantageous embodiment, abrasive media residues on or at the component are quantitatively determined or recorded, in particular as a relative or absolute value.

### BRIEF DESCRIPTION OF THE DRAWINGS

An exemplary embodiment is clarified in the following with reference to the figure:

FIG. 1: shows in a schematic view the steps of an exemplary method in accordance with the present invention.

### DETAILED DESCRIPTION

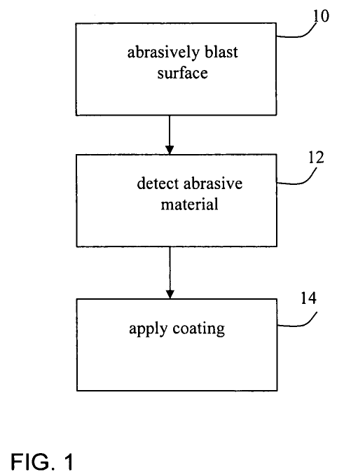

As mentioned, FIG. 1 shows the steps of an exemplary method according to the present invention which, in this case, is a method for producing surface coatings on gas turbine components, in particular gas turbine components of aircraft engines, and for measuring abrasive material residues at or on gas turbine components, in particular gas turbine components of aircraft engines.

In step 10, a surface of the gas turbine component is abrasively blasted using an abrasive material, a portion of this abrasive material remaining on or in this surface of the component. In this context, an abrasive material is used which, in comparison to the material or base material of the gas turbine component, absorbs or reflects electromagnetic radiation in defined spectral regions in a different manner or at a different intensity.

In step 12, abrasive material is detected which has remained on or in the surface of the gas turbine component. For this purpose, the particular or previously abrasively blasted surface or surface section of the gas turbine component is irradiated with electromagnetic radiation, either abrasive material particles, which have remained on or in the surface of the gas turbine part, being individually detected at a geometrically high resolution, and the surface-area proportion being determined, or the integral change in the reflectivity and/or emissivity being recorded.

In step 14, a coating is applied to the surface of the gas turbine component, in particular to the surface of the gas turbine component previously abrasively blasted using the abrasive material. The coating is applied in a thermal spray-coating process.

It may be provided, however, for this coating process to only be carried out in step 14 when it has been previously verified and determined whether, respectively, that the abrasive material on or in the surface of the gas turbine component, respectively its (surface-area) proportion relative to this surface is smaller than a predefined limit.

As clarified, in particular, by the exemplary embodiment, the present invention provides the basis for a multiplicity of advantages, some of which are named in the following, it being noted that not all of the exemplary embodiments which come under the present invention need feature the or all of these advantages. By employing (the design approach in accordance with the exemplary embodiment of) the method according to the present invention, abrasive media residues are quantitatively determined. In contrast to previously known designs, it is possible to inspect the component to be coated, respectively the gas turbine component. In addition, a rapid, contactless measurement of the abrasive media residues (also described here as abrasive material residues) is made possible. The need for ground specimens is eliminated; the quality is known immediately following the abrasive blasting

### LIST OF REFERENCE NUMERALS

10 abrasively blast surface
12 detect abrasive material
14 apply coating

What is claimed is:

1. A method for producing surface coatings on components and/or for measuring abrasive material residues on components comprising the steps of:
abrasively blasting a surface of the component using an abrasive material, a portion of the abrasive material remaining on or in the surface of the component;
detecting abrasive material remaining on or in the surface of the component; and if the abrasive material is detected,
applying a coating to the surface of the component.

2. The method as recited in claim 1 wherein the detecting step is a contactless process.

3. The method as recited in claim 1 wherein the detecting step is a nondestructive process.

4. The method as recited in claim 1 wherein the detecting step includes applying radiation to the blasted surface of the component.

5. The method as recited in claim 4 wherein the radiation is light radiation or infrared radiation.

6. The method as recited in claim 4 wherein the detecting step includes individually detecting particles of the abrasive material at a geometrically high resolution.

7. The method as recited in claim 1 wherein the detecting step includes determining or measuring a surface-area proportion of the abrasive material remaining on or in the surface of the component.

8. The method as recited in claim 1 wherein the detecting step includes measuring or recording an integral change in the reflectivity and/or emissivity in the region of the abrasively blasted surface of the component.

9. The method as recited in claim 1 wherein the applying step occurs only coating only when an amount or proportion of the abrasive material remaining on or in the surface of the component is smaller than a predefined limit.

10. The method as recited in claim 1 wherein the applying step includes a thermal spray-coating process.

11. The method as recited in claim 1 wherein the component is a gas turbine component.

12. The method as recited in claim 1 wherein the gas turbine component is an aircraft engine gas turbine component.
